(19) United States
(12) Patent Application Publication
(10) Pub. No.: US 2014/0169840 A1
(43) Pub. Date: Jun. 19, 2014

(54) IMAGE FORMING APPARATUS

(71) Applicant: CANON KABUSHIKI KAISHA, Tokyo (JP)

(72) Inventors: Ken Yokoyama, Suntou-gun (JP); Tsubasa Takeuchi, Mishima-shi (JP)

(73) Assignee: CANON KABUSHIKI KAISHA, Tokyo (JP)

(21) Appl. No.: 14/102,988

(22) Filed: Dec. 11, 2013

(30) Foreign Application Priority Data
Dec. 17, 2012 (JP) 2012-275003

(51) Int. Cl. G03G 15/01

(52) U.S. Cl. CPC G03G 15/1615
USPC 399/298; 399/299; 399/302

(57) ABSTRACT

The image forming apparatus is capable of changing a state between a first state in which only a first image bearing member and transfer belt contact each other, and a second state in which respective image bearing members are separated from the transfer belt. A second transfer member is located at a first separating portion at which the second transfer member is separated from the image bearing member in the first state, and is located at a second separating portion closer to the second image bearing member than the first separating portion in the second state to regulate the position of the transfer belt.

### BACKGROUND OF THE INVENTION

1. Field of the Invention

The present invention relates to an electrophotographic type image forming apparatus such as a copying machine or printer which can form a multi-color image.

2. Description of the Related Art

As an image forming apparatus such as a copying machine or page printer, an electrophotographic type image forming apparatus has been known conventionally. In the electrophotographic type image forming apparatus, the surface of a drum-like photosensitive member (to be referred to as a “photosensitive drum” hereinafter) serving as an image bearing member is uniformly charged and exposed by an exposure device based on image information, thereby forming an electrostatic latent image. A developing device develops the electrostatic latent image formed on the photosensitive drum as a toner image. The toner image is formed onto a transfer medium such as paper by using electrostatic force. Then, the toner image is fused and fixed onto the transfer medium by heat and pressure applied by a fixing device, and is discharged as an output image. Recent electrophotographic type image forming apparatuses are achieving advanced functions such as color printing and higher speed. Color image forming apparatuses for an electrophotographic process, which include an intermediate transfer belt for coping with these functions, have been widely employed.

As an example of electrophotographic type color image forming apparatuses, there is known an image forming apparatus which adopts an intermediate transfer belt as an intermediate transfer member. Toner images in yellow, magenta, cyan, and black (to be referred to as Y color, M color, C color, and Bk color hereinafter) are formed by a plurality of image forming stations and transferred to the intermediate transfer belt. These toner images are then transferred at once to a recording medium at a secondary transfer portion.

Japanese Patent Application Laid-Open No. 2010-102320 discloses an arrangement in which the primary transfer roller of each image forming station is moved to bring an intermediate transfer belt and each photosensitive drum into contact with each other or separate them from each other.

However, the intermediate transfer belt generates a flutter or ruffle to a certain degree during rotation. To reliably separate the intermediate transfer belt and primary transfer roller in consideration of these factors, a separation amount as large as possible is required. This sometimes hinders downsizing of the image forming apparatus. This problem arises not only in the intermediate transfer belt but also in an arrangement which adopts a conveyance belt for conveying a transfer medium.

### SUMMARY OF THE INVENTION

The purpose of the present invention is to provide an image forming apparatus in which the separation distances between an image bearing member, an endless belt serving as an intermediate transfer belt or transfer medium conveyance belt, and a transfer member are satisfactorily ensured to reduce wear of the transfer member when the belt is driven.

Another purpose of the present invention is to provide an image forming apparatus including an endless transfer belt that is rotatable, a plurality of image bearing members that bear toner images, and a plurality of transfer members arranged at positions corresponding to the plurality of image bearing members through the transfer belt, wherein the plurality of transfer members transfers the toner images from the corresponding image bearing members to the transfer belt and is movable in a direction in which the plurality of transfer members contact the transfer belt during an image formation and is separated from the plurality of image bearing members during a non-image formation, wherein one of the plurality of transfer members is a regulating transfer member configured to regulate a position of the transfer belt by moving to a first separating portion at which the regulating transfer member is separated from the corresponding image bearing member much more than during the image formation, and a second separating portion located at a position closer to the image bearing member than the first separating portion, and when the regulating transfer member is located at the second separating portion, the corresponding image bearing member and the transfer belt are separated, the transfer belt and the regulating transfer member contact each other, and the remaining transfer members are separated from the transfer belt.

Another purpose of the present invention is to provide an image forming apparatus including an apparatus main body, an endless transfer belt that is rotatable, a first image bearing member that bears a toner image, a plurality of image bearing members including a second image bearing member configured to bear a toner image of a color different from a color of the first image bearing member, a first transfer member configured to be arranged at a position corresponding to the first image bearing member through the transfer belt and transfer a toner image from the first image bearing member to the transfer belt, and a plurality of transfer members configured to be arranged at positions corresponding to the plurality of image bearing members through the transfer belt and transfer toner images from the corresponding image bearing members to the transfer belt, wherein the apparatus main body is capable of changing a state between a partially-contacting state for mono-color print as the first state in which only the first image bearing member and the transfer belt contact each other, and an all-separating state as the second state in which the first image bearing member and the respective image bearing members are separated from the transfer belt, and a second transfer member arranged in correspondence with the second image bearing member among the plurality of transfer members is located at the first separating portion at which the second transfer member is separated from the second image bearing member in the partially contacting state for mono-color print, and is located at the second separating portion closer to the second image bearing member than the first separating portion in the all-separating state to regulate a position of the transfer belt.

Further features of the present invention will become apparent from the following description of exemplary embodiments with reference to the attached drawings.

### BRIEF DESCRIPTION OF THE DRAWINGS

FIG. 1 is a sectional view of the schematic arrangement of a color image forming apparatus as an embodiment of an image forming apparatus according to the present invention.

FIG. 2A is a sectional view of a schematic arrangement showing a all-separating state when transfer members and photosensitive drums are separated in a color image forming apparatus according to the first embodiment.

FIG. 2B is a sectional view of a schematic arrangement showing a partially contacting state for mono-color print when the transfer members and photosensitive drums are partially separated in the mono-color mode in the color image forming apparatus according to the first embodiment.

FIG. 2C is a sectional view of a schematic arrangement showing the position of the notch of an intermediate transfer unit in the partially contacting state for mono-color print.

FIG. 3A is a schematic perspective view of the intermediate transfer unit which controls the contact-separation operation of a primary transfer roller, in order to explain the contact-separation operation of the primary transfer roller.

FIGS. 3B and 3C are schematic enlarged perspective views of a notch 25 in order to explain the contact-separation operation of the primary transfer roller.

FIG. 4A is a schematic sectional view of the operation of the intermediate transfer unit when the photosensitive drum and primary transfer roller contact each other.

FIG. 4B is a schematic sectional view of the operation of the intermediate transfer unit when the primary transfer roller of the intermediate transfer unit is located at the first separating portion.

FIG. 4C is a schematic sectional view of the operation of the intermediate transfer unit when the primary transfer roller is located at the second separating portion.

FIG. 4D is a schematic sectional view of the operation of the intermediate transfer unit when the primary transfer roller is not born at the second separating portion.

FIG. 5 is a schematic sectional view of a primary transfer portion showing a separating state according to the second embodiment of the present invention.

FIG. 6A is a sectional view of the schematic arrangement of a conventional color image forming apparatus.

FIG. 6B is a sectional view of the schematic arrangement of the conventional color image forming apparatus showing separation at a conventional primary transfer portion.

### DESCRIPTION OF THE EMBODIMENTS

Preferred embodiments of the present invention will now be described in detail in accordance with the accompanying drawings.

An image forming apparatus according to the present invention will be described in detail below with reference to the accompanying drawings.

### First Embodiment

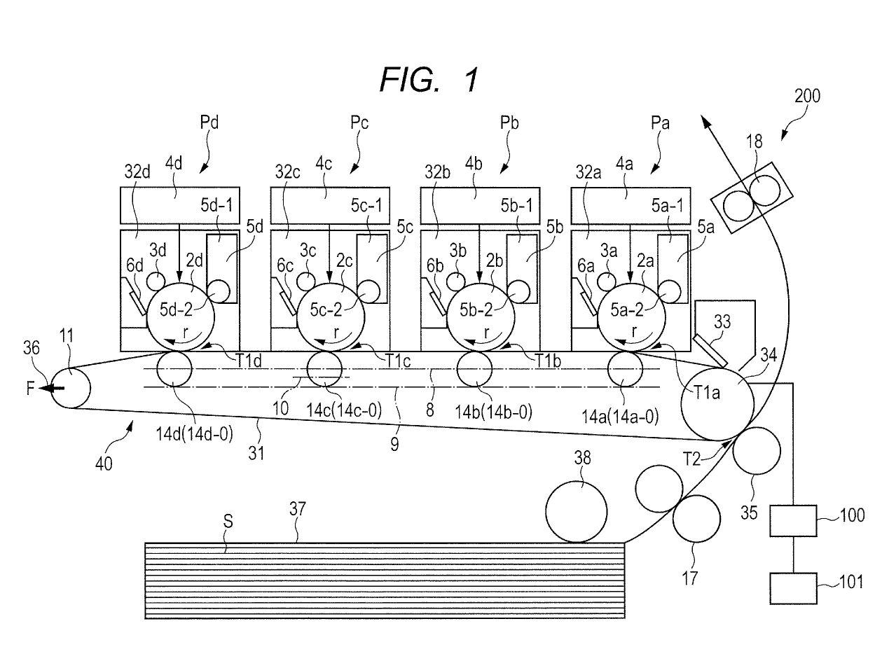

FIG. 1 is a view showing the schematic arrangement of a color image forming apparatus 200 using an intermediate transfer method as an embodiment of the image forming apparatus according to the present invention. The color image forming apparatus 200 in the embodiment employs a tandem intermediate transfer method. More specifically, a plurality of image forming stations P (Pa, Pb, Pc, and Pd) including drum-like photosensitive members, i.e., photosensitive drums 2 (2a, 2b, 2c, and 2d) serving as first image bearing members form toner images of respective colors.

The color image forming apparatus 200 includes the yellow (Y color), magenta (M color), cyan (C color), and black (Bk color) image forming stations P (Pa, Pb, Pc, and Pd) arranged from the upstream side of image formation. Alphabetical letters a, b, c, and d are suffixed to the reference numerals or symbols of members forming the respective image forming stations P in the order of Y, M, C, and Bk colors to discriminate these members. When no alphabetical letter is added, the description is common to all of the image forming stations P.

Each image forming station P includes a process cartridge 32 and exposure unit 4. The Y color image forming station Pa, M color image forming station Pb, C color image forming station Pc, and Bk color image forming station Pd are disposed in the rotational direction of an intermediate transfer belt 31 serving as an endless transfer belt (to be described later).

The process cartridges 32 are four independent process cartridges 32 (32a, 32b, 32c, and 32d) for Y, M, C, and Bk each including the photosensitive drum 2 serving as an image bearing member, a charging roller 3, a developing unit 5, and a cleaning unit 6. The process cartridge 32 is detachable from the apparatus main body. Toner images of the different colors formed by the process cartridges 32 are sequentially superposed and transferred onto the intermediate transfer belt 31, and then secondarily transferred onto a transfer medium S at once, thereby obtaining a full-color image. The transfer medium S is fed from a paper feed cassette 37 and discharged onto a discharge tray (not shown).

Details of the color image forming apparatus 200 according to the embodiment will be explained. Since the internal arrangements and operations of the respective process cartridges 32 are almost the same, the operation of the Y color process cartridge 32a will be representatively explained.

The photosensitive drum 2a is a rotating drum type photosensitive member and is driven to rotate in a direction indicated by an arrow r at a predetermined peripheral velocity (process speed). The process speed of the image forming apparatus 200 in the embodiment changes depending on the type of the transfer medium S.

The primary charging roller 3a uniformly charges the photosensitive drum 2a serving as an image bearing member to a potential of a predetermined polarity (negative voltage in the embodiment). The photosensitive drum 2a is exposed by the exposure unit 4a constructed from a laser diode, polygon scanner, lens group, and the like, thereby forming an electrostatic latent image corresponding to the Y color component of the image signal.

After that, the developing unit 5a visualizes the electrostatic latent image formed on the photosensitive drum 2a by developing it into a toner image by using a Y color toner. The developing unit 5a includes a toner container 5a-1 which contains toner, and a developing roller 5a-2 which bears and conveys toner. The developing roller 5a-2 is made of a resistance-adjusted elastic rubber. The developing roller 5a-2 contacts the photosensitive drum 2a while rotating in the forward direction. By applying a voltage of a predetermined polarity (negative voltage in the embodiment) to the developing roller 5a-2, the toner which is born on the developing roller 5a-2 while being friction-charged to the same polarity in each developing unit 5 is transferred to the electrostatic latent image on the photosensitive drum 2a to develop the image.

In the embodiment, the intermediate transfer member is the intermediate transfer belt 31 serving as a rotatable endless belt, as described above. The intermediate transfer belt 31 is driven to rotate in contact with the photosensitive drum 2a by the action of a driving roller 34 at almost the same peripheral velocity as that of the photosensitive drum 2a. A driving source 100 rotates the driving roller 34 and is controlled by a control unit 101 (controller). The intermediate transfer belt 31 is an endless film-like member having a volume resistivity of 10⁸ to 10¹² Ω·cm and a thickness of 65 μm.

A primary transfer member 14a is arranged at a position where it faces the photosensitive drum 2a through the intermediate transfer belt 31. In the embodiment, the primary transfer member 14a is a primary transfer roller 14a which is a rotatable roller. The primary transfer roller 14a is rotated following the rotation of the intermediate transfer belt 31, and when it does not receive the rotation of the intermediate transfer belt 31, stops. Note that the primary transfer roller 14a is formed from a low-hardness material. More specifically, the primary transfer roller 14a is a resistance-adjusted sponge rubber roller having a hardness of 17° to 23° (Asker-C hardness) and a volume resistivity of 10⁶ to 10⁷ Ω·cm.

The photosensitive drum 2a and primary transfer roller 14a form a primary transfer nip (primary transfer portion) T1a through the intermediate transfer belt 31. When the toner image born on the photosensitive drum 2a passes through the primary transfer portion T1a, it is transferred from the photosensitive drum 2a onto the intermediate transfer belt 31 by the action of static electricity generated by a positive voltage applied to the primary transfer roller 14a. The cleaning unit 6a removes and recovers the primary transfer residual toner remaining on the photosensitive drum 2a after transferring the toner image from the photosensitive drum 2a to the intermediate transfer belt 31.

The above-described process is performed similarly even in the process cartridges 32b, 32c, and 32d for C, M, and Bk colors, superposing a full-color toner image on the intermediate transfer belt 31. The full-color toner image superposed on the intermediate transfer belt is transferred to the transfer medium S by a secondary transfer roller 35 at a secondary transfer nip T2.

The image forming apparatus 200 according to the embodiment includes the secondary transfer roller 35 which is arranged on the outer surface side of the intermediate transfer belt 31 to face the driving roller 34 in contact with the inner surface of the intermediate transfer belt 31. The driving roller 34 and secondary transfer roller 35 form the secondary transfer nip T2 through the intermediate transfer belt 31. The resistance of the secondary transfer roller 35 is adjusted to a volume resistivity of 10⁷ to 10⁹ Ω·cm.

The transfer medium S picked up by a pickup roller 38 from the paper feed cassette 37 is synchronized and fed toward the secondary transfer nip T2 by a registration roller pair 17 which is driven to rotate at a predetermined timing. The full-color toner image formed on the intermediate transfer belt 31 is transferred onto the transfer medium S by the action of static electricity generated by a voltage applied to the secondary transfer roller 35. A fixing device 18 fixes the full-color toner image to the transfer medium S by heat and pressure, and then the transfer medium S is discharged from the apparatus (from the image forming apparatus main body). A belt cleaning device 33 serving as a cleaning means removes and recovers the secondary transfer residual toner remaining on the intermediate transfer belt 31 after transferring the toner image from the intermediate transfer belt 31 to the transfer medium S.

A tension roller 11 and the driving roller 34 are arranged on the inner surface side of the intermediate transfer belt 31. The tension roller 11 makes the intermediate transfer belt 31 keep applying a tension in a direction indicated by an arrow 36 at a tension force F of 10 kgf. The driving roller 34 is constituted by coating a metal cored bar with silicone rubber at a thickness of 100 μm.

The contact-separation arrangement of the primary transfer roller 14 as a feature of the present invention will be explained. The primary transfer roller 14 can move in a direction in which it comes into contact with the photosensitive drum 2 through the intermediate transfer belt 31 or is separated from the photosensitive drum 2. The movement of each primary transfer roller 14 is achieved by a driving unit. In the embodiment, two levels of the first separating portion and second separating portion (to be described later) are set as separating retraction portions of the primary transfer roller 14 in the image forming station P of at least one color. A transfer member having these two separating portions serves as a regulating transfer member. The regulating transfer member has a feature of taking the second separating portion in a all-contacting state as the third state and the first separating portion in a mono-color mode.

The general color image forming apparatus 200 can execute a full-color mode at the full-color image formation in which the plurality of image forming stations P function, and a mono-color mode at the mono-color image formation in which only one image forming station P functions. The color image forming apparatus 200 can select the mode because, if the photosensitive drum 2 of the image forming station P which does not function at the image formation in the mono-color mode keeps in contact with the intermediate transfer belt 31, the surface of the photosensitive drum 2 is worn owing to the contact with the intermediate transfer belt 31, shortening the lifetimes of the image forming station P and photosensitive drum 2. To solve this, an intermediate transfer unit which adjusts the contacting state between the intermediate transfer belt 31 and the photosensitive drum 2 in the image forming station P of the color image forming apparatus 200 takes three states: a all-separating state, mono-color mode, and full-color mode. Details of the intermediate transfer unit will be described later.

As described above, even the image forming apparatus according to the embodiment has three states.

(1) At the full-color image formation, the primary transfer rollers 14 serving as transfer members in the plurality of image forming stations P and the photosensitive drums 2 form the nips T1 through the intermediate transfer belt 31, forming the contacting state. At the full-color image formation, toner images are transferred from the photosensitive drums 2 of the plurality of image forming stations P to the intermediate transfer belt 31 to superpose color images onto the intermediate transfer belt 31. (All contacting state).

(2) At the mono-color image formation, only the photosensitive drum 2d of the achromatic image forming station Pd forms the nip T1d together with the primary transfer roller 14d through the intermediate transfer belt 31, forming the contacting state. At the mono-color image formation, a toner image is transferred from the photosensitive drum 2d to the intermediate transfer belt 31.

### (Partially Contacting State for Mono-Color Print).

(3) At the non-image formation, a separating state in which the photosensitive drums 2 of the plurality of image forming stations P and the intermediate transfer belt 31 do not contact each other is formed. (All-separating state).

By operating each primary transfer roller 14, the contacting state at the full-color image formation, the contacting state at the mono-color image formation, and the separating state at the non-image formation can be executed and switched.

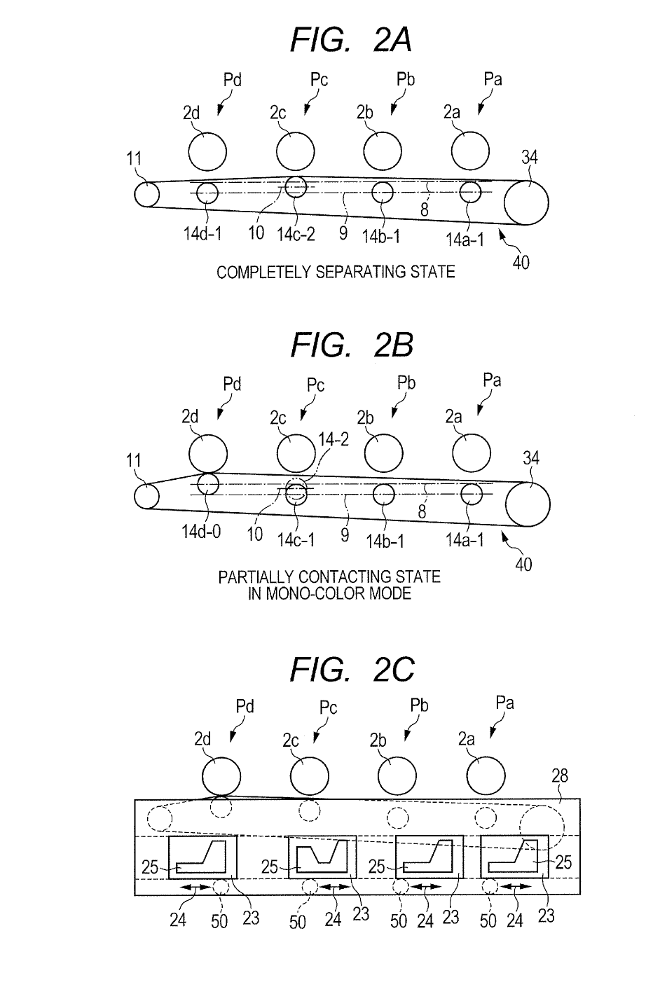

First, the all-separating state and the mono-color mode will be explained in detail with reference to FIGS. 2A to 2C. In the embodiment, the primary transfer roller 14c of the C color image forming station Pc serving as the third image forming station has two separating portions, i.e., a first separating portion 14c-1 and second separating portion 14c-2. The primary transfer rollers 14a, 14b, and 14d of the remaining stations, i.e., the first, second, and fourth stations Pa, Pb, and Pd have the first separating portions 14a-1, 14b-1, and 14d-1.

The first separating portion is a retraction portion of the primary transfer roller 14 set so that the intermediate transfer belt 31 and photosensitive drum 2 are reliably separated and the primary transfer roller 14 and intermediate transfer belt 31 are reliably separated regardless of the flutter of the intermediate transfer belt during rotation. The second separating portion is a retraction portion of the primary transfer roller 14 set so that the intermediate transfer belt 31 and photosensitive drum 2 are reliably separated, and the primary transfer roller 14 raises the intermediate transfer belt 31 and is stably rotated following the rotation of the intermediate transfer belt 31.

The all-separating state of an intermediate transfer unit 40 will be explained first with reference to FIG. 2A.

The respective image forming stations Pa, Pb, Pc, and Pd will be called the first, second, third, and fourth stations sequentially.

In the all-separating state at the non-image formation shown in FIG. 2A, the primary transfer rollers 14a, 14b, and 14d of the first, second, and fourth stations Pa, Pb, and Pd are moved to the first separating portions 14a-1, 14b-1, and 14d-1, and the primary transfer roller 14c of the third station Pc is moved to the second separating portion 14c-2.

The third station Pc sets the primary transfer roller 14c to the second separating portion 14c-2 by retracting the center of the rotating shaft of the primary transfer roller 14c to the position of the level 10, and implements separation between the photosensitive drum 2c and the intermediate transfer belt 31 while raising the intermediate transfer belt 31. The first, second, and fourth stations Pa, Pb, and Pd move the centers of the rotating shafts of the primary transfer rollers 14a, 14b, and 14d to the position of the level 9, and retract the primary transfer rollers 14a, 14b, and 14d of the first, second, and fourth stations Pa, Pb, and Pd to the first separating portions 14a-1, 14b-1, and 14d-1. The first, second, and fourth stations Pa, Pb, and Pd implement separation between the photosensitive drums 2 and the intermediate transfer belt 31 while reliably separating the primary transfer rollers 14a, 14b, and 14d and the intermediate transfer belt 31.

The separation amounts between the intermediate transfer belt 31 and the primary transfer rollers 14a, 14b, and 14d of the remaining stations Pa, Pb, and Pd can be ensured to be large by the distance by which the primary transfer roller 14c of the third station Pc raises the intermediate transfer belt 31.

Next, the mono-color mode at the mono-color image formation will be explained with reference to FIG. 2B.

According to the embodiment, in the mono-color mode, the intermediate transfer belt 31 contacts the photosensitive drum 2d for image formation in the fourth station Pd for Bk color (achromatic color), and is separated in the remaining color stations Pa, Pb, and Pc. That is, the center of the rotating shaft of the primary transfer roller 14d is moved to a level 8 at the contacting time, and the primary transfer roller 14d is located at a contacting portion 14d-0 (FIG. 2B). At this time, if the primary transfer roller 14c of the third station Pc remains at the level 10 in the all-separating state (i.e., the second separating portion 14c-2 shown in FIG. 2A), the clearance between the primary transfer roller 14c and the intermediate transfer belt 31 is small. To prevent the contact of the intermediate transfer belt 31 and primary transfer roller 14c owing to, e.g., the flutter of the belt upon driving the intermediate transfer belt 31, the center of the rotating shaft of the primary transfer roller 14c of the third station Pc that is located at the level 10 in the all-separating state is retracted to the level 9 (FIG. 2B). As for the third station Pc, the separating portion at the level 9 is a reliable separating portion from the intermediate transfer belt 31 in the mono-color mode, and serves as the first separating portion 14c-1.

Next, the contact-separation operation of the intermediate transfer belt 31 to and from the photosensitive drum 2 along with the image forming operation will be described with reference to FIGS. 1 and 2A to 2C. An image forming operation in the full-color mode will be explained first.

At the start of the image forming operation, the image forming apparatus is in the all-separating state of FIG. 2A. When the image forming operation starts, the intermediate transfer belt 31 and photosensitive drum 2 start rotating. The primary transfer roller 14c of the third station Pc is in contact with the intermediate transfer belt 31 and rotated following the rotation of the intermediate transfer belt 31. The contact linear pressure between the primary transfer roller 14c and the intermediate transfer belt 31 in the all-separating state is 3 gf/cm, which is satisfactory for rotation following the rotation of the intermediate transfer belt 31. Reliable following rotation suppresses wear.

After the intermediate transfer belt 31 and photosensitive drum 2d reach a predetermined peripheral velocity, the primary transfer roller 14d contacts the photosensitive drum 2d through the intermediate transfer belt 31, as shown in FIG. 1. The centers of the rotating shafts of the primary transfer rollers 14 move to the contacting portions at the level 8, and the primary transfer rollers 14 (14a, 14b, 14c, and 14d) of the respective image forming stations P (Pa, Pb, Pc, and Pd) achieve contact between the photosensitive drums 2 and the intermediate transfer belt 31. More specifically, the primary transfer rollers 14a, 14b, 14c, and 14d are arranged at the contacting portions 14a-0, 14b-0, 14c-0, and 14d-0. After the end of the image forming process, the rotating shafts of the primary transfer rollers 14a, 14b, and 14d of the first, second, and fourth stations Pa, Pb, and Pd move to the level 9, and the primary transfer rollers 14a, 14b, and 14d move to the first separating portions 14a-1, 14b-1, and 14d-1, as shown in FIG. 2A. Also, the rotating shaft of the primary transfer roller 14c of the third station Pc moves to the level 10, and the primary transfer roller 14c retracts to the second separating portion 14c-2. The photosensitive drums 2 and intermediate transfer belt 31 stop the rotation, ending the image forming operation.

Next, an image forming operation in the mono-color mode will be explained. In FIG. 2B, only the fourth station for Bk color contacts the intermediate transfer belt 31. Similar to the full-color mode, after the intermediate transfer belt 31 and photosensitive drum 2 reach a predetermined peripheral velocity, the primary transfer roller 14d contacts the photosensitive drum 2d through the intermediate transfer belt 31. That is, the primary transfer roller 14d is arranged at the contacting portion 14d-0. At the same time, the rotating shaft of the primary transfer roller 14c of the third station Pc is moved to the level 9, and the primary transfer roller 14c is retracted to the first separating portion 14c-1 to ensure a sufficient clearance from the intermediate transfer belt 31. In this manner, the primary transfer roller 14c is a regulating transfer member which can move between the first and second separating portions to regulate the belt position.

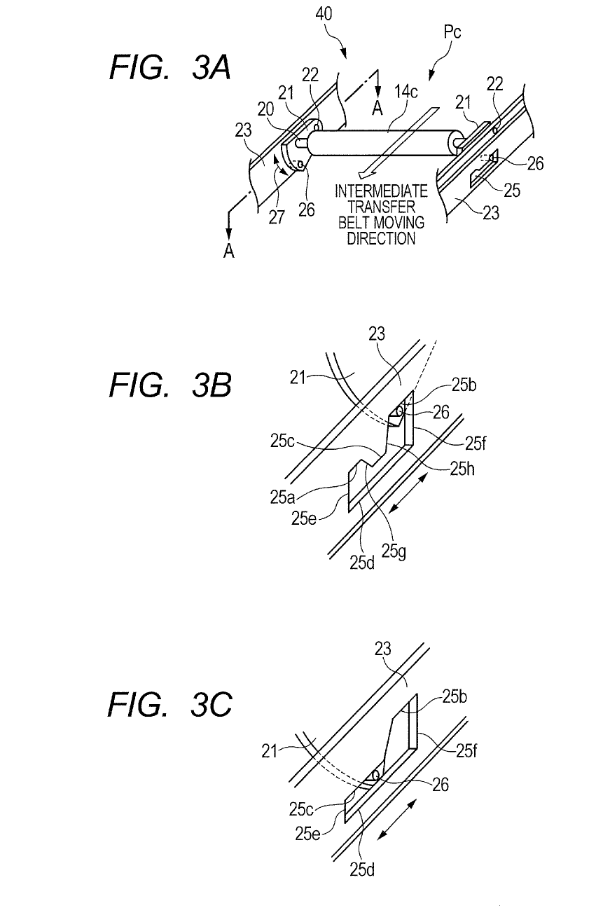

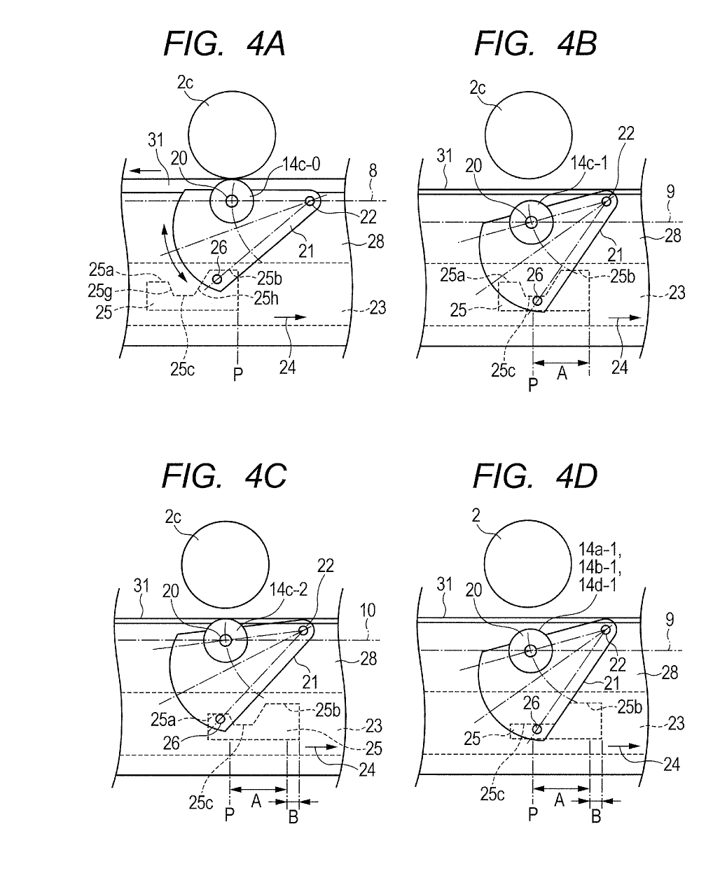

A contact-separation mechanism in the intermediate transfer unit 40 of the primary transfer roller 14c of the third station Pc will be described in detail with reference to FIGS. 3A to 3C and 4A to 4D. FIG. 3A is a schematic perspective view of the primary transfer portion T1c of the third station Pc. FIG. 3B shows the notch of the sliding member of the third station Pc. FIG. 3C shows the notch of the sliding member of each of the first, second, and fourth stations Pa, Pb, and Pd. FIGS. 4A, 4B, and 4C are schematic side views of FIG. 3A and show the primary transfer roller 14c in the third station Pc at the contacting portion 14c-0, first separating portion 14c-1, and second separating portion 14c-2, respectively. FIG. 4D is a schematic side view showing the primary transfer rollers 14a, 14b, and 14d in the first, second, and fourth stations Pa, Pb, and Pd at the first separating portions 14a-1, 14b-1, and 14d-1.

Referring to FIGS. 2C and 3A, the intermediate transfer unit 40 includes the primary transfer rollers 14 (14a, 14b, 14c, and 14d), bearing members 21 which hold the primary transfer rollers 14 (14a, 14b, 14c, and 14d), respectively, sliding members 23 each having a notch 25, and intermediate transfer unit-side plates 28. As will be understood by referring to FIGS. 2C and 3A, the sliding members 23 are slidably born by the intermediate transfer unit-side plates 28, and are driven in directions indicated by arrows 24 by driving means 50 controlled by the control unit 101 in accordance with the separating or contacting state of the primary transfer rollers 14. The notch 25 is formed in the sliding member 23. The sliding direction of the sliding member 23 is almost the same as the rotational direction of the intermediate transfer belt 31 at the primary transfer portion T1. The sliding member 23 slides in a predetermined range.

The third station Pc will be described with reference to FIGS. 3A, 3B, 4A, 4B, and 4C. A cored bar 20 of the primary transfer roller 14c is loosely inserted in each bearing member 21. The bearing member 21 is made of a highly slidable material and ensures rotation of the primary transfer roller 14c. The bearing member 21 is attached to the intermediate transfer unit-side plate 28 so that it can swing in directions indicated by an arrow 27 by using a rotating shaft 22 as the fulcrum. Further, press springs (not shown) are arranged on the bearing members 21 on the two sides to press the primary transfer roller 14c against the photosensitive drum 2c in the contacting direction. In other words, the primary transfer roller 14c can contact the photosensitive drum 2c by the spring force at a predetermined pressure.

The notch 25 of the third station Pc has a predetermined shape in the sliding direction. The base at the lower portion is a side 25d parallel in the sliding direction. The notch 25 has two sides 25e and 25f extending vertically from the base 25d on the two sides of the base 25d having a predetermined length. As shown in FIGS. 3A, 3B, and 3C, the notch 25 also has upper sides 25a, 25b, and 25c parallel to the sliding direction.

In the separation operation of the primary transfer roller 14c, the upper side 25a, 25b, or 25c of the notch 25 catches a boss 26 projecting from the bearing member 21 and controls upward movement of the boss 26. That is, upward movement of the boss 26 by the force of the spring used in the bearing member 21 is regulated to regulate the swing of the bearing member 21, that is, movement of the primary transfer roller 14 toward the photosensitive drum 2 and intermediate transfer belt 31. For example, in the embodiment, as shown in FIG. 4A, the level of the upper portion of the notch that contacts the boss 26 changes along with movement of the sliding member 23 in the right-and-left direction (directions indicated by the arrow 24). That is, the levels of the sides 25a, 25b, and 25c are different. The notch 25 has a shape capable of adjusting the primary transfer roller 14c to the first separating portion 14c-1, second separating portion 14c-2, or contacting portion 14c-0 (to be described later) in accordance with one of the sides 25a, 25b, and 25c of the notch 25 that contacts the boss 26.

More specifically, to set the primary transfer roller 14c, which is adjusted by the boss 26, to the portion 14c-0 (FIG. 4A) where the primary transfer roller 14c contacts the intermediate transfer belt 31 and photosensitive drum 2c, the boss 26 is prevented from contacting the upper side 25b of the notch. That is, the side 25b forms a notch of a level enough to move the boss satisfactorily upward. The press spring can sufficiently push up the bearing member 21. As a result, the intermediate transfer belt 31, photosensitive drum 2c, and primary transfer roller 14c contact each other.

To move the primary transfer roller 14c to the first separating portion 14c-1, the upper side 25c of the notch 25 is formed at a position lower than the upper side 25b by that much. Among the upper sides of the notch, the side 25c is located at the lowest level at which the boss 26 is lowered to locate the primary transfer roller 14c to the first separating portion 14c-1. The boss 26 is caught by the side 25c (FIG. 4B). In accordance with the position of the boss 26 caught by the side 25c, the swinging bearing member 21 moves down and as a result, the primary transfer roller 14c is lowered to the first separating portion 14c-1.

This also applies to the case of the second separating portion 14c-2. In movement to the second separating portion 14c-2, the boss 26 is caught by the side 25a. In accordance with the position of the boss 26 caught by the side 25a, the swinging bearing member 21 moves down and thus the primary transfer roller 14c is lowered to the second separating portion 14c-2 (FIG. 4C). Note that the side 25a is located above the side 25c and below the side 25b. Sides 25g and 25h of the notch that connect the upper sides of the notch are substantially inclined to smooth almost up-and-down movement of the boss 26 that is switched along with right-and-left movement of the sliding member 23.

Note that the notch need not always have the above-described shape, and the notch shape may be formed by a curve as long as the vertical position of the boss 26 can be adjusted by right-and-left movement of the sliding member 23 and the contact-separation distance of the primary transfer roller 14 can be further adjusted.

As described above, in FIG. 4A showing the contacting state of the primary transfer roller 14c, the primary transfer roller 14c contacts the photosensitive drum 2c through the intermediate transfer belt 31. The primary transfer roller 14c and photosensitive drum 2c receive the force of pressing the bearing member 21 by the press spring (not shown), and the primary transfer roller 14c contacts the photosensitive drum 2c at a desired set pressure. The boss 26 projecting from the bearing member 21 does not contact any side of the notch 25.

In FIG. 4B showing the separating state of the primary transfer roller 14c at the first separating portion 14c-1, the sliding member 23 moves by a distance A from a start point P of the notch 25 in the direction indicated by the arrow 24, and the boss 26 contacts the sliding member at the upper side 25c of the notch 25. Thus, the rotating shaft 20 of the primary transfer roller 14c is moved to the position of the level 9, and the primary transfer roller 14c is retracted to the first separating portion 14c-1. The intermediate transfer belt 31 is separated from the photosensitive drum 2c, and the primary transfer roller 14c does not contact the intermediate transfer belt 31.

In FIG. 4C showing the separating state of the primary transfer roller 14c at the second separating portion 14c-2, the sliding member 23 moves by a distance A+B from the start point P in the direction indicated by the arrow 24, and the boss 26 contacts the sliding member 23 at the upper side 25a of the notch 25. While raising the intermediate transfer belt 31, the primary transfer roller 14c is retracted to the second separating portion 14c-2 where it is separated from the photosensitive drum 2c.

FIG. 4D shows the first separating state of the primary transfer rollers 14a, 14b, and 14d in the first, second, and fourth stations Pa, Pb, and Pd. As shown in FIGS. 3C and 4D, only the side 25c is formed at the upper portion of the notch 25 to move the rotating shafts 20 of the primary transfer rollers 14a, 14b, and 14d to the level 9. Even when the sliding members 23 are moved in the direction indicated by the arrow 24, the primary transfer rollers 14a, 14b, and 14d take only two states, i.e., the first separating portion (14a-1, 14b-1, and 14d-1) shown in FIG. 4D and the contacting portion (14a-0, 14b-0, and 14d-0) shown in FIG. 1.

The contact-separation arrangement and operation in the embodiment have been described above.

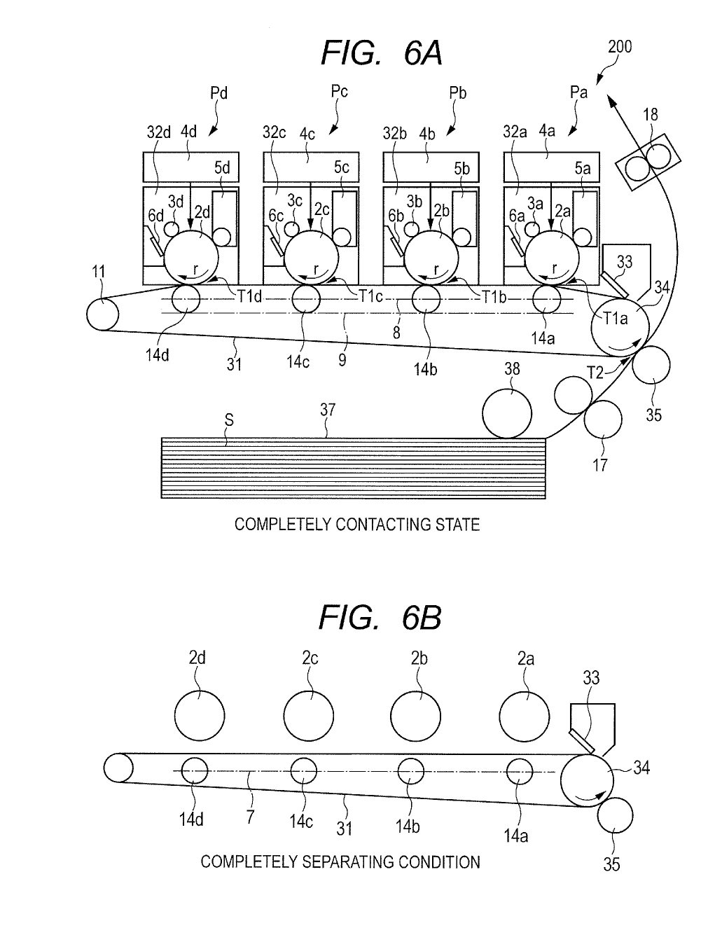

Next, the effects of the embodiment will be explained using the above-mentioned related art shown in FIGS. 6A and 6B as a comparative example.

In a separating state according to the comparative example, a clearance of 0.5 mm is ensured to separate the intermediate transfer belt 31 and primary transfer roller 14 with respect to a surface (to be referred to as a tension-applied surface hereinafter) on which the driving roller 34 and tension roller 11 make the intermediate transfer belt 31 keep applying a tension. Also, in FIG. 2A showing the separating state according to the embodiment, the first separating portions 14a-1, 14b-1, and 14d-1 of the primary transfer rollers 14a, 14b, and 14d of the first, second, and fourth stations Pa, Pb, and Pd are set to be equal to the all-separating portion in the comparative example (ensure a clearance of 0.5 mm with respect to the tension-applied surface). As the arrangement unique to the embodiment, the primary transfer roller 14c of the third station Pc raises the intermediate transfer belt 31 by 2.5 mm from the tension-applied surface. Hence, the intermediate transfer belt 31 is raised by 0.8 mm, 1.7 mm, and 1.3 mm from the tension-applied surface at the respective positions of the first, second, and fourth stations Pa, Pb, and Pd. Table 1 below summarizes the clearances between the primary transfer roller 14 and the intermediate transfer belt 31 in the separating state in the embodiment and comparative example.

TABLE 1

| | First | Second | Third | Fourth |
|---|---|---|---|---|
| | Station | Station | Station | Station |
| | (Pa) | (Pb) | (Pc) | (Pd) |
| Embodiment | 1.3 mm | 2.2 mm | 0.0 mm | 1.8 mm |
| | | | (contact) | |
| Comparative | 0.5 mm | 0.5 mm | 0.5 mm | 0.5 mm |
| Example | | | | |
| (Related Art) | | | | |

The surface position at which a tension is applied is defined by measuring the positions of the driving roller 34 and tension roller 11 by a three-dimensional measurement device while the intermediate transfer belt 31 is dismounted from the intermediate transfer unit 40. It also suffices to measure the positions of the primary transfer rollers 14 (14a, 14b, 14c, and 14d) similarly by the three-dimensional measurement device. This also applies to the primary transfer roller at the second separating portion, the driving roller 34, and the surface of the intermediate transfer belt at which a tension is applied by the primary transfer roller at the second separating portion and the tension roller 11. A plurality of portions of each of the primary transfer roller 14, driving roller 34, and tension roller 11 in the longitudinal direction are measured and averaged to calculate the positions of the surface at which a tension is applied and primary transfer roller 14. Table 1 represents the clearances between the primary transfer rollers 14 and the intermediate transfer belt 31 at the calculated separating portions.

In the embodiment, unlike the comparative example, the clearances between the intermediate transfer belt 31 and the primary transfer rollers 14a, 14b, and 14d in the stations Pa, Pb, and Pd except for the third station Pc can be increased to more reliably separate the intermediate transfer belt 31 and primary transfer rollers 14.

As described above, at least one color station, e.g., the third station Pc takes the two levels of the first separating portion 14c-1 and second separating portion 14c-2 for retraction portions of the primary transfer roller 14c as the separating state between the primary transfer roller and the photosensitive drum. By taking the second separating portion 14c-2 in the all-separating state and the first separating portion 14c-1 in the mono-color mode, the effects unique to the embodiment are obtained.

At the positions of the respective image forming stations P in the separating state, the clearances between the remaining primary transfer rollers 14a, 14b, and 14d and the intermediate transfer belt 31 can be ensured to be large by the distance by which the primary transfer roller 14c at the second separating portion 14c-2 raises the intermediate transfer belt 31. Since the intermediate transfer belt 31 is supported by the driving roller 34, the tension roller 11, and the primary transfer roller 14c located between them, the flutter of the intermediate transfer belt 31 in driving can be suppressed. Therefore, the primary transfer rollers 14a, 14b, and 14d and the intermediate transfer belt 31 can be reliably separated to suppress the wear of the primary transfer rollers 14 caused by the peripheral velocity difference.

In the embodiment, the second separating portion 14c-2 is set for the primary transfer roller 14c of the third station Pc, but the second separating portion may be set for another color station. In particular, when the second separating portion is set for an image forming station P located near the center, it becomes easier to raise the intermediate transfer belt 31 and ensure the clearance between the intermediate transfer belt 31 and the primary transfer rollers 14. The flutter of the intermediate transfer belt 31 can be further suppressed.

By the ensured clearance, the first separating portion can be set to be closer to the photosensitive drum 2. By setting the first separating portion to be closer to the photosensitive drum 2, the contact-separation stroke can be shortened. The movable space of each member can be reduced by the shortening of the contact-separation stroke, and the volume of the intermediate transfer unit 40 can be reduced, implementing downsizing of the main body and attendant reduction of the material cost.

### Second Embodiment

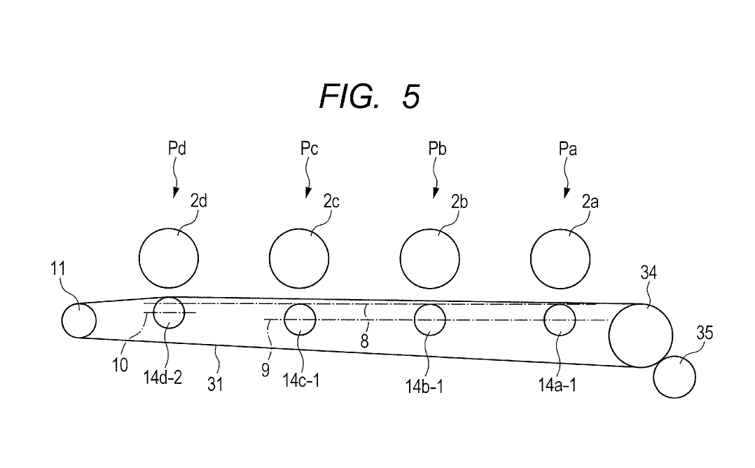

The second embodiment has a feature in which the second separating portion is set for the separating portion of an achromatic station that functions in the mono-color image forming mode. This will be described in detail with reference to FIG. 5.

FIG. 5 shows a separating state according to the second embodiment. First, second, and third stations Pa, Pb, and Pc are chromatic stations, and a fourth station Pd is a Bk color (achromatic) image forming station. The first, second, and third stations Pa, Pb, and Pc retract to a level 9 of first separating portions 14a-1, 14b-1, and 14c-1. The fourth station Pd retracts to a level 10 of a second separating portion 14d-2. A primary transfer roller 14d of the fourth station Pd at the second separating portion (level 10) 14d-2 raises an intermediate transfer belt 31 by 2.5 mm. As a result, the intermediate transfer belt 31 is raised by 0.2 mm, 0.8 mm, and 1.9 mm from the surfaces at each of which a tension is applied at the respective positions of the first, second, and third stations Pa, Pb, and Pc. Unlike a comparative example, the second embodiment can effectively obtain clearances between the primary transfer rollers 14 and the intermediate transfer belt 31 in the separating state, as represented by Table 2 below. As the comparative example, the related art in FIGS. 6A and 6B were used similarly to the first embodiment.

TABLE 2

| | First | Second | Third | Fourth |
|---|---|---|---|---|
| | Station | Station | Station | Station |
| | (Pa) | (Pb) | (Pc) | (Pd) |
| Embodiment | 0.7 mm | 1.3 mm | 2.4 mm | 0.0 mm |
| | | | | (contact) |
| Comparative | 0.5 mm | 0.5 mm | 0.5 mm | 0.5 mm |
| Example | | | | |
| (Related Art) | | | | |

In the full-color mode and mono-color mode, the primary transfer roller 14d of the fourth station Pd moves to a contacting level 8, i.e., a contacting portion 14d-0, and contacts a photosensitive drum 2d through the intermediate transfer belt 31. The fourth station Pd can form an image by setting only the two, second separating portion 14d-2 and contacting portion 14d-0 of the primary transfer roller 14d.

As an effect unique to the second embodiment, the second separating portion is set for a station which functions in the mono-color mode, so the two, first and second separating portions need not be set for one station, unlike the first embodiment. Since the two separating levels need not be set for a single station, the contact-separation arrangement can be simplified.

Although an image forming apparatus including an intermediate transfer belt has been exemplified as the arrangement of the image forming apparatus according to the present invention, the present invention is similarly applicable to an image forming apparatus including a transfer medium conveyance belt configured to convey a transfer medium. The arrangement of the image forming apparatus including the transfer medium conveyance belt is known to those skilled in the art, and a detailed description thereof will be omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-275003, filed Dec. 17, 2012, which is hereby incorporated by reference herein in its entirety.

What is claimed is:

1. An image forming apparatus comprising:
an endless transfer belt that is rotatable;
a plurality of image bearing members that bear toner images; and
a plurality of transfer members arranged at positions corresponding to the plurality of image bearing members through the transfer belt, wherein the plurality of transfer members transfers the toner images from the corresponding image bearing members to the transfer belt and is movable so as to contact the transfer belt during an image formation and is separated from the plurality of image bearing members during a non-image formation,
wherein one of the plurality of transfer members is a regulating transfer member configured to regulate a position of the transfer belt by moving to a first separating portion at which the regulating transfer member is separated from the corresponding image bearing member much more than during the image formation, and a second separating portion located at a position closer to the image bearing member than the first separating portion, and when the regulating transfer member is located at the second separating portion, the corresponding image bearing member and the transfer belt are separated, the transfer belt and the regulating transfer member contact each other, and the other transfer members are separated from the transfer belt.

2. An apparatus according to claim 1, wherein when the transfer belt is separated from the remaining transfer members, the regulating transfer member is located at the second separating portion to increase distances between the other transfer members and the transfer belt.

3. An apparatus according to claim 1, wherein the regulating transfer member includes a rotatable roller, and when the regulating transfer member is located at the second separating portion, performs driven in contact with the transfer belt.

4. An apparatus according to claim 1, wherein in a all-separating state in which all the image bearing members and the belt are separated, the regulating transfer member is located at the first separating portion.

5. An apparatus according to claim 1, wherein the image bearing member corresponding to the regulating transfer member includes an image bearing member configured to bear a chromatic toner image.

6. An apparatus according to claim 1, wherein one of the plurality of image bearing members is an image bearing member configured to bear an achromatic toner image, the apparatus main body is capable of executing a mono-color mode in which only the achromatic toner image is transferred to the transfer belt, and when executing the mono-color mode, the regulating transfer member is located at the first separating portion.

7. An apparatus according to claim 1, wherein the transfer belt includes an intermediate transfer belt configured to transfer a toner image from the image bearing member.

8. An apparatus according to claim 1, wherein the transfer belt includes a recording medium conveyance belt configured to convey a recording medium to which a toner image is transferred from the image bearing member.

9. An image forming apparatus comprising:
an apparatus main body;
an endless transfer belt that is rotatable;
a first image bearing member that bears a toner image;
a plurality of image bearing members including a second image bearing member configured to bear a toner image of a color different from a color of the first image bearing member;
a first transfer member configured to be arranged at a position corresponding to the first image bearing member through the transfer belt and transfer a toner image from the first image bearing member to the transfer belt; and
a plurality of transfer members configured to be arranged at positions corresponding to the plurality of image bearing members through the transfer belt and transfer toner images from the corresponding image bearing members to the transfer belt,
wherein the apparatus main body is capable of changing a state between a first state in which only the first image bearing member and the transfer belt contact each other, and a second state in which the first image bearing member and the respective image bearing members are separated from the transfer belt, and
a second transfer member arranged in correspondence with the second image bearing member among the plurality of transfer members is located at the first separating portion at which the second transfer member is separated from the second image bearing member in the first state, and is located at the second separating portion closer to the second image bearing member than the first separating portion in the second state to regulate a position of the transfer belt.

10. An apparatus according to claim 9, wherein in a case where the second transfer member is positioned at the second separating portion, the transfer belt separates from the second image bearing member and contacts the second transfer member.

11. An apparatus according to claim 9, wherein the second transfer member includes a rotatable roller, and when the second transfer member is located at the second separating portion, performs driven in contact with the transfer belt.

12. An apparatus according to claim 9, wherein the first image bearing member is located at a most downstream position in a rotational direction of the transfer belt.

13. An apparatus according to claim 12, wherein the second image bearing member is adjacent to the first image bearing member in the rotational direction of the transfer belt.

14. An apparatus according to claim 12, wherein the first image bearing member bears an achromatic toner image.

15. An apparatus according to claim 14, wherein the plurality of image bearing members are a plurality of image bearing members configured to bear toner images of different chromatic colors.

16. An apparatus according to claim 14, wherein the apparatus main body can switch a state between a third state in which all the first image bearing member and the plurality of image bearing members contact the transfer belt, the second state, and the first state.

17. An apparatus according to claim 9, further comprising a driving unit configured to drive the first transfer member and the plurality of transfer members with respect to the transfer belt, the driving unit including a sliding member,
wherein the sliding member moves in a direction parallel to a rotational direction of the transfer belt to move the first transfer member and the plurality of transfer members.

18. An apparatus according to claim 9, wherein the transfer belt includes an intermediate transfer belt configured to transfer a toner image from the image bearing member.

19. An apparatus according to claim 9, wherein the transfer belt includes a recording medium conveyance belt configured to convey a recording medium to which a toner image is transferred from the image bearing member.

20. An apparatus according to claim 9, wherein when driving of the transfer belt starts, the apparatus main body is in the second state.
